(19) United States
(12) Patent Application Publication
(10) Pub. No.: US 2011/0006579 A1
(43) Pub. Date: Jan. 13, 2011

(54) FLAME-RETARDANT POLYURETHANE MOLDED FOAMS, PROCESSES FOR PREPARING THE SAME, AND USES THEREFOR

(75) Inventors: Frithjof Hannig, Dusseldorf (DE); Dagmer Ulbrich, Monheim Am Rhein (DE); Thomas Gross, Wermelskirchen (DE); Hans-Guido Wirtz, Leverkusen (DE); Adreas Frahm, Leverkusen (DE); Adreas Hoffmann, Koln (DE)

Correspondence Address: CONNOLLY BOVE LODGE & HUTZ, LLP, P O BOX 2207, WILMINGTON, DE, 19899, US

(73) Assignee: BAYER MATERIALSCIENCE AG, Leverkusen (DE)

(21) Appl. No.: 12/919,575

(22) PCT Filed: Feb. 13, 2009
(86) PCT No.: PCT/EP2009/001007

§ 371 Date: Sep. 17, 2010

(30) Foreign Application Priority Data
Feb. 26, 2008 (DE) 10 2008 011 079.5

(51) Int. Cl. A47C 5/12; B32B 3/26; B32B 5/14; B32B 5/32; C08J 9/00

(52) U.S. Cl. 297/452.1; 428/304.4; 428/310.5; 428/316.6; 521/170

(57) ABSTRACT

Polyurethane molded foams having a surface region and an interior region and comprising a flame-retardant solid, wherein the flame-retardant solid is present in the surface region in a proportion higher than a proportion of the flame-retardant solid in the interior region; processes for preparing the same; and materials comprising such foams.

The invention relates to polyurethane molded foams containing flame-retardant solids (such as ammonium polyphosphate, melamine or expandable graphite), a process for the preparation thereof and the use of such polyurethane molded foams for construction components for which flame-retardant properties are desirable.

Foams have been known for a long time and are widely employed because of their low density and the related saving of material, their excellent thermal and acoustic insulation properties, their mechanical damping property and their particular electrical properties. Thus, foams are found in packaging, in furniture and mattresses, generally in sound and heat insulation, as lifting bodies in water vehicles, as a filter and support material in various industrial fields and as structural elements in the preparation of layered materials, laminates, composites or foam composites.

For many applications, especially in the construction of air, rail and water vehicles, a sufficient fire protection of the foams as demanded in legal directives and a number of other regulations is necessary. The proof that the foams meet the requirements in terms of fire protection properties is shown by means of a large number of different fire protection tests, which are usually oriented by the application of the foam of the composite containing it. Generally, foams must be treated with so-called flame retardants for such fire protection tests to be passed.

Further, the use of compounds containing chlorine or bromine as flame retardants, which are often employed in combination with antimony oxides, is known. However, it is disadvantageous that plastic materials and foams whose inflammability is reduced thereby are extremely difficult to recycle since, for example, halohydrocarbons can hardly be separated from the polymer, and in waste incineration plants, dioxins may be formed from such compounds. In addition, toxic and corrosive gases, such as HCl and HBr, are formed in the case of a fire.

Phosphorus compounds are another class of flame retardant substances with which foams are treated. A particular drawback thereof is the fact that a very high density of flue gas is generated in the case of a fire, like with halogen-containing flame retardants. Because of the toxicity of the flue gases and reduced visibility due to smoke, persons are endangered in the surroundings of the fire, especially in closed rooms, and rescue work is made more difficult.

In order to circumvent the above mentioned drawbacks, WO 2004/056920 A2 describes the use of ammonium sulfate as an (inorganic) flame retardant.

Expandable graphite is to be mentioned as another important inorganic flame retardant. Expandable graphite is a so-called intercalation compound in which molecules are intercalated between the carbon layers of graphite. These molecules are mostly sulfur or nitrogen compounds.

Melamines are also very frequently used in the field of PUR molded foam preparation as known, for example, from GB 2 369 825 A.

Expandable graphite has also long been known as a flame retardant in the field of PUR foam preparation. Under the action of heat, the layers of graphite are driven apart by thermolysis like an accordion; graphite flakes expand. Depending on the kind of expandable graphite, the expansion may start at as low as 150° C. and occur almost abruptly. When expansion is free, the final volume may reach some hundred times the starting volume.

The flame retardant effect of the expandable graphite is based on the formation of such an intumescence layer on the surface. This slows down the extension of the fire and acts against the consequences of fire that are most dangerous to humans, namely the formation of toxic gases and smoke.

The properties of expandable graphite, i.e., starting temperature and expandability, are mainly determined by the intercalation quality (i.e., the number of layers intercalated parallel to the base) and by the intercalation agent.

For expandable graphite, many fields of application have been found in the meantime. Thus, for example, it is used in insulating foams (for example, PU rigid foam sheets), flexible foams (for example, in furniture, mattresses etc.), carpets, textiles, artificial resin coatings, plastic sheets, plastic coatings, rubber materials (for example, conveyor belts) and pipe seals.

The facts that expandable graphite displays a high flame-retardant effect already at a low quantity, is inexpensive and causes a reduced smoke evolution are considered particular advantages thereof. In addition, it is free of halogen and heavy metals.

In view of these advantages, it is not astonishing that there have been many endeavors for using expandable graphite in various foam materials.

Thus, for example, DE 103 02 198 A1 describes the alternative use of expandable graphite as a flame retardant in polyurethane foams.

DE 39 09 017 C1 describes a process for the preparation of a flame-retardant elastic polyurethane flexible foam from a foam reaction mixture comprising a polyol and a polyisocyanate as well as a proportion of expandable graphite in the form of platelets as a flame retardant, wherein the size of the platelets is on the same order of magnitude as that of the forming foam cell walls, the expandable graphite being admixed with the reaction component polyol at first and being incorporated in the foam upon foaming in a way to form at least part of the cell walls.

In addition, DE 40 10 752 A1 describes the additional use of melamine in polyurethane foams in addition to expandable graphite.

A general problem of many solid flame retardants, such as expandable graphite, results from the fact that such solids are not soluble in the polyol component. This has the consequence that the dispersion of the polyol component and the flame retardant must be stirred continuously to avoid sedimentation of the flame retardant in the storage container and to ensure a homogeneous distribution of the flame retardant within the foam. In addition, melamines have the undesirable property to cake very quickly upon sedimentation, which makes the redispersing of the solids cake substantially more difficult.

A further drawback of flame retardants that are not soluble in the polyol component is to be seen in the fact that these cause a significant abrasion of the mixing head, so that components contained therein must be replaced more frequently, which again results in higher production cost. In addition, when high-pressure mixing heads are used in the processing of polyurethane raw materials, very high shear forces occur in such mixing heads wherein the solid particles, such as expandable graphite, are highly affected and their flame retardant property may be deteriorated thereby.

Another disadvantage of the processes described in the above mentioned documents is to be seen in the fact, in particular, that the flame retardant is distributed (homogeneously) throughout the foam material and thus can be found in places where a flame retardant is not necessary at all or far less urgently so (such as in the interior of a polyurethane molded foam). This results in a disproportionately high consumption of such a flame retardant. In addition, the presence of solid flame retardants distributed throughout the polyurethane molded foam can undesirably change the mechanical properties of the polyurethane molded foam.

To avoid such problems, the prior art describes composite materials which contain another foam material, such as a melamine resin foam (for example Basotect® of the BASF AG) in the case of EP 1 867 455 A2, in addition to an expandable graphite as a solid-containing PUR molded part. However, such approaches also have some drawbacks.

Thus, the melamine rigid foams are prepared by the condensation of melamine and formaldehyde. This results in increased formaldehyde values in the end application of this material, which is undesirable, for example, in the automobile field, but also in the furniture field.

In addition, the melamine rigid foam described (Basotect®) can be purchased only as slabstock (supplied by the BASF AG, production in Ludwigshafen and Schwarzheide, Germany) and thus must be cut for the respective applications. For this reason, the freedom of design is highly restricted already in this production step.

If the two materials PUR and melamine rigid foam are compared, the melamine rigid foam exhibits a low compression set in terms of loss of height and supportability as well as a low performance in tensile strength tests (from the Abstract Book of the VDI Fachtagung “Polyurethan 2005” held on Jan. 26 and 27, 2005, in Baden-Baden, Germany).

Therefore, it is an object of the present invention to provide both a polyurethane molded foam and a process for the preparation of such a polyurethane molded foam by which the drawbacks of the prior art as described above are avoided. In particular, it is an object of the present invention to optimize the use of flame-retardant solids, such as ammonium polyphosphate, melamine or expandable graphite (referred to as “solid” hereinbelow), as a flame retardant in terms of quantity in such a way that a flame-retardant effect is achieved especially at those sites of a polyurethane molded foam where it is necessary. This results in a reduction of the required quantity of the solid.

It is also an object of the present invention to design both the polyurethane molded foam and the process for the preparation thereof in such a way that the extent of flame retardancy can be adjusted selectively and variably.

In a first embodiment, the object of the present invention is achieved by a polyurethane molded foam which is characterized in that the proportion of a flame-retardant solid in its surface region is higher than the proportion of such flame-retardant solid in an interior region of the polyurethane molded foam.

In a preferred embodiment, the polyurethane molded foam according to the invention includes one or more different polyurethanes and at least one flame-retardant solid.

In addition, the polyurethane molded foam according to the invention is preferably a flexible foam, i.e., which is prepared using those molding foams that leave flexible bodies after curing.

As used herein, “flame-retardant solids” means material(s) and mixtures admixed with a polymer matrix in order to reduce an extension of fire in the case of a fire. Particularly preferred are ammonium phosphate, melamine or expandable graphite alone or in combination with one another.

This can be achieved by delayed ignition, slower burning, reduced heat release rate, prevented dripping (while burning) of material, or a self-extinguishing effect.

The various activities of the flame-retardant solids relevant to the present invention are tested, for example, in the following fire tests:
FMVSS 302: burning rate, among others
Cone Calorimeter: heat release rate, among others
NF P 92-501 (Epiradiateur Test): time to ignition, among others
UL 94: dripping (while burning), among others
BS 5852 Part 2 (“Crib 5”): self-extinguishing, among others

“Proportion of the solid in a surface region/interior region of the polyurethane molded foam” means the mass and/or volume proportion of the solid in a defined, but variable volume, wherein the comparison involves comparing the proportions of two similarly dimensioned, but spatially non-overlapping volumes, namely one near the surface and one in the interior of the polyurethane molded foam.

Such a structure of a polyurethane molded foam containing a solid according to the invention requires enrichment of the solid in the surface region of the polyurethane molded foam, i.e., in the region exposed to a source of fire. Thus, a flame retardant is incorporated in the foam body mainly, or even exclusively, where it is required. This means significant savings in terms of necessary amount of solid.

“Larger” with respect to the comparison of the two volumes according to the present invention means that the proportion of solid in a volume within the surface region is preferably larger by at least 10%, more preferably by at least 20%, than the proportion of the solid in a volume in an interior region of the foam body.

The processes, to be discussed in more detail below, for the preparation of the polyurethane molded foam allows to design it in such a way that the proportion of solid increases continuously or discontinuously from the interior of the polyurethane molded foam to its surface. A “discontinuous increase” means kind of abrupt increases in which regions with different proportions of solid can be distinguished, but wherein these regions themselves need not have been prepared discontinuously. Conversely, if the proportion of solid increases continuously, a discontinuous production of different regions or layers is also possible, in which case such regions or layers are not particularly delimited from one another (for example, visually).

It is further preferred that the polyurethane molded foam according to the invention comprises at least two full-area or partial-area layers of the same or different foam compositions that are distinguished at least in the proportion of solid.

It can be easily appreciated that a better adaptation to the actual danger situation can be achieved by such a gradient structure. For example, if the polyurethane molded foam according to the invention is used as a seat shell, the upper surface, which is designed as the actual seating surface, is certainly to be considered more exposed as compared to the lower surface facing the floor. Thus, the upper layer would have to have a higher proportion of solid as compared to the lower layer.

Further, it is possible that the polyurethane molded foam comprises at least one surface layer containing one or more flame-retardant solids and at least one layer free of flame-retardant solid.

The advantage resides in further savings of the amount of solid required. Thus, for example, a further development of the seat shell described just above is possible by selecting a three-layered structure which comprises a foam layer with a high flame-retardant solids content, a foam layer free of flame-retardant solid and a foam layer with a lower flame-retardant solids content.

According to the invention, it is not required that the whole surface of the polyurethane molded foam comprises the material “enriched with solid”. Rather, within the meaning of the present invention, it is preferred that only a defined region of the surface, namely the region that is particularly exposed to elevated temperatures in the case of a fire, is treated accordingly.

Further, it is preferred that the surface region enriched with a flame-retardant solid has a layer thickness within a range of from 0.2 mm to the maximum thickness of a seat cushion, especially within a range of from 1 mm to 2 cm.

Alternatively or cumulatively, the proportion of the flame-retardant solid in the surface region can be within a range of from 1 to 80% by weight, especially within a range of from 5 to 30% by weight.

It can be easily understood that these two variable quantities, i.e., the layer thickness of the surface region containing the flame-retardant solid on the one hand and the proportion of flame-retardant solid in this layer on the other, can be used to adjust the flame protection property (almost) at will. Accordingly, a larger layer thickness and larger proportions of flame-retardant solid result in a higher flame protection property. However, too large a layer thickness and/or too high proportions of the flame-retardant solid are less preferred since correspondingly large amounts would be needed. Due to these two antagonistic tendencies, the upper and lower limits described above as being preferred are obtained.

Further, the density of the surface region containing the flame-retardant solid or solids is within a range of from 10 to 800, especially up to 2000 kg/m³, especially within a range of from 30 to 200, especially up to 900 kg/m³. Such low densities achieve significant savings of weight in the resulting polyurethane molded foam, which is in turn advantageous for many applications (for example, in the use as a seat in vehicles, because correspondingly less fuel will be necessary to move the vehicle).

In addition to the solid, the polyurethane molded foam according to the invention may also contain at least one further solid and/or liquid flame-retardant additive. Namely, by incorporating not only one flame-retardant substance into the polyurethane molded foam, the flame-retardant effect can be not only enhanced, but adapted more purposefully to the actual requirements.

The polyurethane molded foam according to the invention may also comprise a full-area or partial-area (decoration) layer. This (decoration) layer may also be a PUR molded foam or PUR elastomer, for example, which is favorably preliminarily inserted in the mold in the process to be described below. Other decoration materials (textiles, non-wovens etc.) are also conceivable.

In a second embodiment, the object of the invention is achieved by a process for the preparation of a polyurethane molded foam as defined above in which a liquid and/or solid flame-retardant substance is incorporated in a reaction mixture of a polyol component and an isocyanate component, and the thus obtained mixture is employed for forming the polyurethane molded foam, characterized in that the ratio R of the amount of incorporated flame-retardant substance to the amount of reaction mixture is constant within a defined time interval, but is different from this ratio in a subsequent second time interval.

In this connection too, the term “amount” may relate to either an amount defined by mass or an amount defined by volume.

The two time intervals, on which the comparison is based, for the formation of a gradient of the flame-retardant solid in the polyurethane molded foam are of equal length. In contrast, the length of the two (equally long) time intervals is not subject to any limitation in the present invention, i.e., can be chosen freely.

A “comparison of two time intervals” does not necessarily mean that the time intervals recurred to for comparison must be within the same process for forming the foam (for example, applying a PUR raw material). It may also mean (equally long) time intervals within different application processes (for example, applying a jet of solid-containing PUR on the one hand, followed by applying a jet of solid-free PUR on the other) of the polyurethane molded foam.

Due to the fact that the ratio R of the amount of incorporated solid to the amount of foam raw material can be adjusted at will (perhaps within certain limits), polyurethane molded foams having quite different distributions of flame-retardant solid can be realized within the polyurethane molded foam.

Such a process is highly suitable for providing different regions of a polyurethane molded foam with different amounts of flame-retardant substances.

When liquid flame-retardant substances are additionally used in addition to solid flame-retardant substances (i.e., solids within the meaning of the present invention), it has been found favorable to incorporate the former into a component used for preparing the foam raw material, i.e., into the polyol or isocyanate component, rather than into the foam raw material. Alternatively or cumulatively, it may be introduced into the component storage vessel or into the component stream flowing to the mixing chamber. In the latter case, it is much more simple to ensure a temporally or quantitatively variable introduction of the liquid flame-retardant substance into the component and thus into the foam raw material.

With the process according to the invention, almost any geometry can be formed (while the flame-retardant layer is applied uniformly), i.e., the material can be employed much more efficiently. In addition, inserts may be employed both in the outer layer and in the inner PUR core.

In addition, the preparation of the polyurethane molded foams may be effected by “wet-in-wet” application. This means that, when layers are applied in several stages, it is not necessary to wait until the PUR material applied in a previous stage has cured completely. Thus, an additional operation for preparing a (finished) interior core is not required, and the PUR formulation (using the corresponding technology) can thus be processed in one operation.

In addition to modifying the layer thickness and the proportion of flame-retarding solid contained therein, the composition of the polyurethane layer may also be varied. For example, a different amount of water in the formulation results in a different extent of cell gas formation and thus allows the layer thickness to be adjusted exactly. However, this may also be done by adding other (chemical or physical) foaming agents. Further, the mixing ratio of polyol and isocyanate may also be changed.

As components for the preparation of the PUR molded foam, polyols and isocyanates that are sufficiently known from the prior art are employed. It has been found possible to replace part of the polyol component by renewable raw materials, such as castor oil or other known vegetable oils, their chemical reaction products or derivatives. Such a replacement does not result in a deterioration of the properties of the finished polyurethane molded foam and is advantageous because such foam bodies highly contribute to renewability.

In this process, it is preferred that the jet containing the flame-retardant solid is directed into the jet of the foam raw material or that a jet of the foam raw material is directed into the solid-containing jet. By this mutual incorporation of the two materials, an optimum cross-linking of the solid with the advantages described above is achieved. In addition, mixing of the solid into a liquid foam raw material is omitted, which avoids the disadvantages described above.

In particular, for an even better cross-linking of the flame-retardant solid with the foam raw material, it is preferred that the flame-retardant solid and the foam raw material is sprayed to form a polyurethane molded foam.

In addition, due to the later metering of the flame-retardant solid into the reaction jet, the risk of damaging the pumps, mixing heads and nozzles by the abrasive properties of these solids does not exist.

A further preferred process variant is characterized in that a foam layer containing a flame-retardant solid is charged in a form, especially in a mold, and another foam material which does not contain a flame-retardant solid or has a lower proportion of solid is applied thereto. Such a discontinuous application of different layers with different proportions of solid significantly simplifies the process.

The foam layer containing a flame-retardant solid is preferably charged by completely or partially spraying in or at an open mold. Subsequently, the foam layer having a lower proportion of flame-retardant solid may be applied to the previously charged layer either also by spray application or by casting (optionally after closing the mold).

One variant of the present invention consists in first preparing a non-flame-retarded flexible foam and then spraying it afterwards with a flame-retarded layer.

In the process according to the invention, the bulk density of the mixture of foam raw material and flame-retardant substance employed for application is preferably adjusted within a range of from 10 to 800, especially up to 2000, more particularly within a range of from 30 to 200, especially up to 900, kg/m³.

Since inclined or vertical surfaces may also be sprayed with the polyurethane provided with the flame-retardant solid by the process according to the invention, an increased thixotropy may be reasonable. This increased thixotropy can be achieved by using the different reactivities of the materials employed (for example, amines, polyethers, amino-modified polyethers, varied catalysis etc.) for selectively adjusting the viscosity of the reaction mixture. Such a modification for selectively adjusting the thixotropy is known from the literature. Thus, Guether, Markusch and Cline described the use of “Non-sagging Polyurethane Compositions” on the Polyurethanes Conference 2000 (Oct. 8 to 11, 2000).

In a third embodiment, the object of the present invention is achieved by the use of the polyurethane molded foam according to the invention as a flame-retarding sound and/or heat insulation, filling or sealing material.

### EXAMPLES

The polyurethane molded foams according to the invention, especially flexible molded foams, may be prepared as a molded part having any of a wide variety of geometries.

In a first process step, a polyol/isocyanate mixture was sprayed on one mold surface. The mold was oriented in such a way that it could be sprayed on uniformly from all sides. The mixing of polyols and isocyanates took place in a mixing head (mixing element).

In the Examples according to the invention (1-4), the polyol/isocyanate mixture was sprayed in an amount of about 600 g (corresponding to a spraying time of about 45 seconds), while the solid was blown into the reaction mixture at 1.5 to 4.5 g per second.

In the Examples according to the invention (5-12), the polyol/isocyanate mixture was sprayed with an output rate of about 37 g/s, while the solid was blown into the reaction mixture at 2.0 to 8.2 g per second.

In a second process step, the mold was then filled with foam by means of a reaction injection machine in an open or closed mold filling mode with a bulk density of from 60 to 65 g/l (Examples 1-4) or with a bulk density of 55 g/l (Examples 5-12). It was not necessary to wait for the reaction of the sprayed polymer mixture to be complete, but the back-foaming could be effected directly due to the more efficient operation (i.e., wet-in-wet).

Optionally, as shown in this Example, a formulation with an amount of water different from that of the spray-on skin could be used. The formulations according to the invention are described at the end of the Example.

After the demolding time, the composite of sprayed exterior layer and foam-backed molded part could then be removed from the mold.

TABLE 1
(Examples 1-4): The following Table 1 shows the different varied
parameters of the Examples according to the invention.

| | | Proportion of | Layer thickness | Spraying time |
|---|---|---|---|---|
| | | expandable | with expandable | Expandable |
| | | graphite | graphite | graphite layer |
| | No. | [g/s] | [mm] | [s] |
| Example | 1 | 1.5 | about 6 | 45 |
| Example | 2 | 3.0 | about 5 | 45 |
| Example | 3 | 4.5 | about 6 | 45 |
| Comparative foam | 4 | 0 | 0 | 0 |
| without expandable | | | | |
| graphite | | | | |

The foams according to the invention prepared in this way were tested in a fire test according to British Standard 5852, Part 2, Crib 5. The following Table shows the results of these fire tests:

TABLE 2
(Examples 1-4):

| | | Proportion of | | Time to |
|---|---|---|---|---|
| | | expandable | Weight loss | self- |
| | | graphite in the | in Crib | extinguishing |
| | | layer | 5 test | in Crib 5 test |
| | No. | [%] | [g] | [min′sec″] |
| Example | 1 | 10 | 21 | 5′35″ |
| Example | 2 | 18 | 21 | 4′55″ |
| Example | 3 | 25 | 21 | 5′40″ |
| Comparative foam | 4 | 0 | extinguished | — |
| without expandable | | | | |
| graphite | | | | |

The fire test according to British Standard 5852, Part 2, Crib 5, is considered as passed if the weight loss is below 60 g and the time to self-extinguishing is below 10 minutes.

TABLE 3
(Examples 5-12):

| | | Output rate of | | Bulk density of the | Spraying time |
|---|---|---|---|---|---|
| | | expandable | Layer | layer provided with | Expandable |
| | | graphite | thickness | expandable graphite | graphite layer |
| | No. | [g/s] | [mm] | [g/l] | [s] |
| Example | 5 | 8.2 | about 2.5-3 | 700 | 25 |
| Example | 6 | 8.2 | about 1.5-2 | 700 | 15 |
| Example | 7 | 4.0 | about 2.5-3 | 650 | 25 |
| Example | 8 | 4.0 | about 1.5-2 | 650 | 15 |
| Example | 9 | 2.4 | about 2.5-3 | 625 | 25 |
| Example | 10 | 2.0 | about 1.5-2 | 625 | 15 |
| Comparative | 11 | 0 | about 2.5-3 | 600 | 25 |
| Example without | | | | | |
| expandable graphite | | | | | |
| Comparative | 12 | 0 | about 1.5-2 | 600 | 15 |
| Example without | | | | | |
| expandable graphite | | | | | |

The foams according to the invention prepared in this way were also tested in a fire test according to British Standard 5852, Part 2, Crib 5. The following Table shows the results of these fire tests:

TABLE 4
(Examples 5-12):

| | | Proportion of | | Time to |
|---|---|---|---|---|
| | | expandable | Weight loss | self- |
| | | graphite in | in Crib | extinguishing |
| | | the layer | 5 test | in Crib 5 test |
| | No. | [%] | [g] | min′sec″ |
| Example | 5 | 18 | 17 | 3′20″ |
| Example | 6 | 18 | 19 | 4′59″ |
| Example | 7 | 10 | extinguished | — |
| Example | 8 | 10 | extinguished | — |
| Example | 9 | 6 | extinguished | — |
| Example | 10 | 5 | extinguished | — |
| Comparative Example | 11 | 0 | extinguished | — |
| without expandable | | | | |
| graphite | | | | |
| Comparative Example | 12 | 0 | extinguished | — |
| without expandable | | | | |
| graphite | | | | |

The fire test according to British Standard 5852, Part 2, Crib 5, is considered as passed if the weight loss is below 60 g and the time to self-extinguishing is below 10 minutes.

Description of the Starting Materials:

Polyol 1: A commercially available trifunctional PO/EO polyether with 80 to 85% primary OH groups and an OH number of 28.

Polyol 2: A commercially available trifunctional PO/EO filled polyether (filler: polyurea dispersion, about 20%) with an OH number of 28.

Polyol 3: A commercially available trifunctional PO/EO polyether with 83% primary OH groups and an OH number of 37.

Polyol 4: A commercially available trifunctional PO/EO polyether with 80 to 85% primary OH groups and an OH number of 35.

Cross-linking agent 1: monoethylene glycol, e.g., ETHYLENGLYKOL supplied by INEOS.

Cross-linking agent 2: diethyltoluenediamine (DETDA), e.g., ETHACURE® 100 Curative supplied by Albemarle Corporation.

Foaming agent: Additive VP.PU 19IF00 A supplied by Bayer AG.

Stabilizer: Tegostab® B 8629, polyether polysiloxane copolymer supplied by Evonik Goldschmidt GmbH.

Color paste: black paste N, e.g., ISOPUR Schwarzpaste N, supplied by iSL-Chemie.

Activator 1: Bis(2-dimethylaminoethyl)ether dissolved in dipropylene glycol, e.g., Niax A 1 supplied by Air Products.

Activator 2: Tetramethyliminobis(propylamine), e.g., Jeffcat Z 130 supplied by Huntsman.

Activator 3: Triethylenediamine in dipropylene glycol, e.g., DABCO 33-LV® Catalyst supplied by Air Products.

Activator 4: Dibutyltin dilaurates (DBTDL), e.g., Keverkat DBTL 162 supplied by Kever-Technologie GmbH & Co. KG.

Polyisocyanate: A prepolymer having an NCO content of about 30% prepared on the basis of binuclear MDI and its higher homologues, and a polyether having an OH number of 28.5 and a functionality of 6.

Foaming Examples:

TABLE 5

| | Formulation of | Formulation of | Formulation of |
|---|---|---|---|
| | sprayed-on layer | sprayed-on layer | foam- |
| | (Examples 1-4) | (Examples 5-12) | backed material |
| Polyol 1 | 76.4 | | 76.4 |
| Polyol 2 | 13.4 | | 13.4 |
| Polyol 3 | 5.7 | | 5.7 |
| Polyol 4 | | 91.15 | |
| Cross-linking | | 2.50 | |
| agent 1 | | | |
| Cross-linking | | 3.00 | |
| agent 2 | | | |
| Water | 1.0 | | 3.2 |
| Blowing agent | | 3.00 | |
| Stabilizer | 0.5 | | 0.5 |
| Color paste | | 0.10 | |
| Activator 1 | 0.05 | | 0.05 |
| Activator 2 | 0.76 | | 0.76 |
| Activator 3 | | 0.20 | |
| Activator 4 | | 0.05 | |
| Polyisocyanate | 21.9 | 34.8 | 56.9 |
| at KZ 100 | | | |

″Grafguard ® Expand FL 160-50 N″ from Graftech was employed as the expandable graphite in Examples 1-4.
″Expofoil PX 99″ was employed as the expandable graphite in Examples 5-12.

1-16. (canceled)

17. A polyurethane molded foam having a surface region and an interior region and comprising a flame-retardant solid, wherein the flame-retardant solid is present in the surface region in a proportion higher than a proportion of the flame-retardant solid in the interior region.

18. The polyurethane molded foam according to claim 17, wherein the proportion of the flame-retardant solid increases continuously from a point in the interior region in at least one direction to a surface of the foam.

19. The polyurethane molded foam according to claim 17, wherein the proportion of the flame-retardant solid increases discontinuously from a point in the interior region in at least one direction to a surface of the foam.

20. The polyurethane molded foam according to claim 17, having at least two foam layers, wherein the at least two foam layers have differing proportions of the flame-retardant solid.

21. The polyurethane molded foam according to claim 17, having at least one surface layer comprising an amount of the flame-retardant solid and at least one layer essentially free of the flame-retardant solid.

22. The polyurethane molded foam according to claim 17, wherein the surface region has a thickness of 1 mm to 2 cm.

23. The polyurethane molded foam according to claim 17, wherein the proportion of the flame-retardant solid in the surface region is 1 to 80% by weight.

24. The polyurethane molded foam according to claim 17, wherein the proportion of the flame-retardant solid in the surface region is 5 to 30% by weight.

25. The polyurethane molded foam according to claim 17, wherein the density of the surface region is 10 to 800 kg/m³.

26. The polyurethane molded foam according to claim 17, wherein the density of the surface region is 30 to 200 kg/m³.

27. The polyurethane molded foam according to claim 17, further comprising at least one additional flame-retardant additive.

28. The polyurethane molded foam according to claim 17, comprising an at least partial-area polyurethane foam cover layer.

29. A process for preparing the polyurethane molded foam according to claim 17, the process comprising: (i) providing a reaction mixture of a polyol component and an isocyanate component; (ii) incorporating the flame-retardant solid in the reaction mixture; and (iii) molding the reaction mixture to form the polyurethane molded foam; wherein the flame-retardant solid is incorporated in the reaction mixture in a first amount during a first time interval and in a second, different amount during a subsequent second time interval.

30. A process for preparing the polyurethane molded foam according to claim 17, the process comprising: (i) mixing the flame-retardant solid with a polyol component or an isocyanate component to form a mixture; (ii) reacting the mixture with the other of the polyol component or the isocyanate component not already present in the mixture to form a foam raw material, and (iii) molding the foam raw material to form the polyurethane molded foam; wherein the flame-retardant solid is present in a first amount in the foam raw material during a first time interval, and in a second, different amount during a subsequent second time interval.

31. The process according to claim 30, wherein the flame-retardant solid is mixed with the polyol component or the isocyanate component with a jet.

32. The process according to claim 30, wherein the foam raw material is sprayed into an open mold.

33. The process according to claim 29, wherein the foam raw material has a bulk density of 10 to 800 kg/m³.

34. The process according to claim 29, wherein the foam raw material has a bulk density of 30 to 200 kg/m³.

35. An insulation or sealing material comprising the polyurethane molded foam according to claim 17.

36. A seating surface comprising the polyurethane molded foam according to claim 17.
